(19) United States
(12) Patent Application Publication
(10) Pub. No.: US 2026/0194164 A1
(43) Pub. Date: Jul. 9, 2026

(54) FLEXIBLE TUBE SUPPORT APPARATUS

(71) Applicant: Sioux Chief Mfg. Co., Inc., Kansas City, MO (US)

(72) Inventors: Jonathan Tobias Ismert, Leawood, KS (US); Brian E. Ismert, Belton, MO (US)

(73) Assignee: Sioux Chief Mfg. Co., Inc., Kansas City, MO (US)

(21) Appl. No.: 19/441,613

(22) Filed: Jan. 6, 2026

Related U.S. Application Data
(60) Provisional application No. 63/742,765, filed on Jan. 7, 2025.

(51) Int. Cl. F16L 3/12; F16L 3/22; F16L 3/237

(52) U.S. Cl. CPC F16L 3/1226; F16L 3/1222; F16L 3/221; F16L 3/237

(57) ABSTRACT

A tube support apparatus supporting an elongate member routed through a building structure. The apparatus includes a grommet securable to a support structure, and a guide member receivable by the grommet. The grommet extends from a leading end to a trailing end and defines a guide receiving opening. The leading end includes an expandable nose and a plurality of flexible fingers configured to compress inward as the grommet is advanced through an access opening and to expand outward to engage a front face of the support structure. The trailing end includes a flange positioned to engage a rear face of the support structure, and a tab extends laterally outward from the trailing end. The guide member includes a head having one or more outwardly projecting barbs configured to compress inward as the head is advanced through the guide receiving opening and to expand outward after passing the nose.

### CROSS-REFERENCE TO RELATED APPLICATIONS

This application claims the benefit of U.S. Provisional Patent Application No. 63/742,765, filed January 7, 2025, the disclosure of which is hereby incorporated herein in its entirety by reference.

### FIELD OF THE INVENTION

This invention relates to supports for flexible tubing, and in particular to a tube support apparatus for supporting a piece of flexible tubing through a run.

### BACKGROUND

Stub-outs for faucets, showerheads, and the like are typically supported between wall studs or other building members by a plumbing strap that extends between and is attachable to adjacent wall studs. The pipe for the stub-out can be soldered to the plumbing strap to fix the position of the stub-out.

The soldering process has several shortcomings. For example, soldering the stub-out pipes to the support strap is labor-intensive and can result in failure of the pipe. Also, in order to allow the stub-out pipes to be soldered to the straps, some straps have been coated with copper oxide after fabrication, a process which produces a thin layer of copper which can easily burn off during soldering, thereby exposing the steel of the strap and creating the potential for galvanic action with the stub-out pipes, which can cause leaks.

In attempts to overcome such shortcomings, prior art pipe hanging systems have included pipe connection members that are clamped to brackets rather than soldered. One such prior art system is the Strong Arm™ bracketing system manufactured and sold by Sioux Chief Mfg. Co. Inc. of Kansas City, MO. The Strong Arm™ system includes a pair of flexible brackets securable to building members and a pipe connection member selectively slidable along the brackets. The pipe connection member can be slid into any desired position along the brackets and fastened in place. One version of the pipe connection member includes front and rear clamping members positioned on opposite sides of the brackets, each of the clamping members including a respective pipe receiving opening sized to receive and support the pipe. The clamping members may be interconnected by at least one threaded fastener adapted for drawing said front and rear clamping members toward one another and against the brackets to fix the pipe connection member in position. A collet is formed integral with one of the clamping members concentric with the respective pipe receiving opening. As the clamping members are drawn toward one another, the collet is compressed against the pipe to fasten it to the pipe connection member. The Strong Arm™ system is available with a bend support member adapted for use with flexible tubing that may be used as an alternative to pipe and must be supported through right-angle bends to avoid kinking.

A problem with prior art pipe hanging systems is that their pipe connection members extend rearward from the plumbing strap and into the area between adjacent building members to which the strap is attached. That area, which may be referred to as the “stud bay,” is often occupied by other building materials or systems, such as waste lines or main sewer lines that may be constructed of PVC (polyvinyl chloride) pipe having a 3-4” diameter or other relatively large diameter. The rearwardly extending pipe connection members of the prior art systems may interfere with such waste lines or may extend so close to such waste lines that bend support members cannot be used.

### SUMMARY

Embodiments of the invention are defined by the claims below, not this summary. A high-level overview of various aspects of the invention is provided here to introduce a selection of concepts that are further described in the Detailed Description section below. This summary is not intended to be used in isolation to determine the scope of the claimed subject matter. In brief, this disclosure describes among other things, a tube support apparatus that supports a piece of flexible tubing through a run.

The tube support apparatus includes a guide member and a grommet. The guide member includes a head having a barb projecting radially outward therefrom. The grommet extends from a leading end to a trailing end and defines a guide receiving opening. The leading end of the grommet includes a nose extending around the guide receiving opening, with the nose comprising expandable nose sections. Flexible fingers project rearward and outward from the nose and are compressible inward relative to the guide receiving opening. The trailing end of the grommet includes a flange situated rearward of and in spaced apart relation from the flexible fingers.

As the head of the guide member is advanced through the guide receiving opening of the grommet, the barb engages the nose sections and urges the nose sections to expand outward until the barb passes the nose, whereupon the nose sections contract around the head rearward of the barb to retain the guide member within the grommet. As the leading end of the grommet is advanced through an access opening formed in a support structure, the flexible fingers engage an edge of the access opening and compress inward until the distal ends of the flexible fingers pass through the access opening, at which point the flexible fingers expand outward to engage a front face of the support structure, and the flange engages a rear face of the support structure, thereby securing the grommet to the support structure.

In certain embodiments, tabs extend laterally outward from positions proximate the trailing end of the grommet. Each tab defines a slot sized to receive a support member such that opposing faces of the support member engage corresponding contact surfaces of the tabs, thereby enabling the grommet to be selectively slid along the support members. In additional embodiments, the tabs may include apertures for receiving fasteners, enabling the grommet to be secured directly to a building member or subfloor, while still receiving the guide member.

### DESCRIPTION OF THE DRAWINGS

Illustrative embodiments of the invention are described in detail below with reference to the attached drawing figures, and wherein:

FIG. 1 is a perspective view of a plurality of tube support assemblies in accordance with an embodiment of the invention secured to a support strap extending between building members, viewed from above and to the right;

FIG. 2 is a perspective view of the assembly of FIG. 1, viewed from above and to the right and depicted with a bend support and a grommet separated for clarity;

FIG. 3 is a perspective view of the assembly of FIG. 1, viewed from above and to the left and depicted with a bend support and a grommet separated for clarity;

FIG. 4 is a perspective view of a grommet of the assembly of FIG. 1, viewed from above;

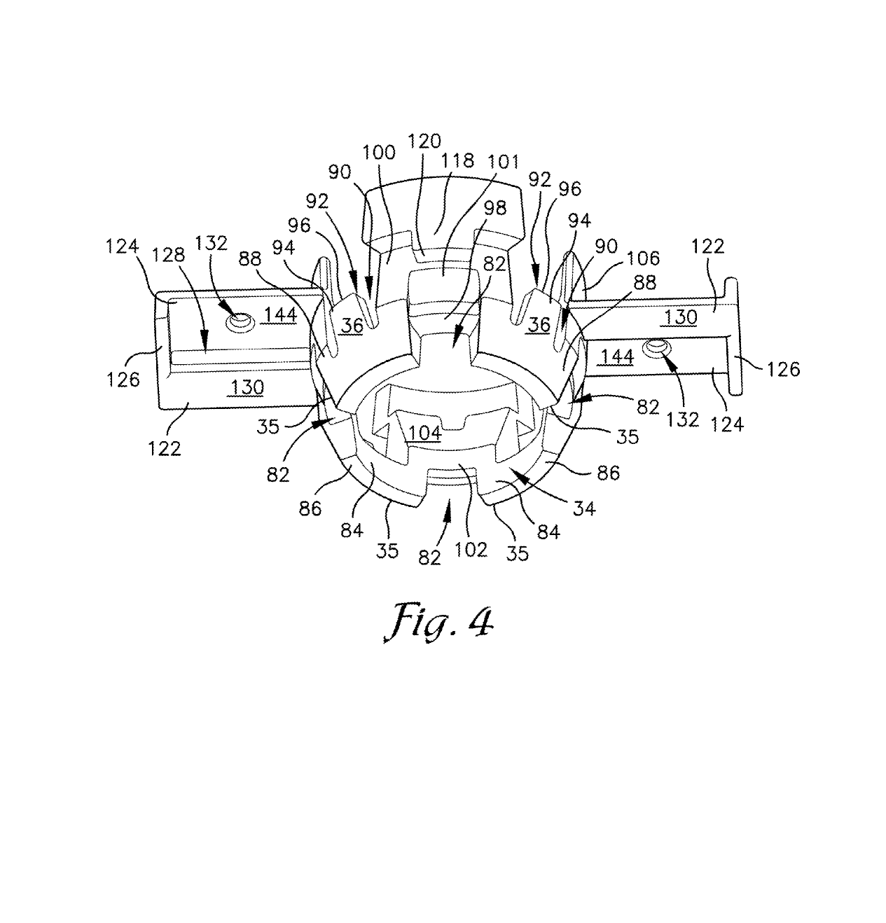

FIG. 5 is a perspective view of a grommet of the assembly of FIG. 1, viewed from below;

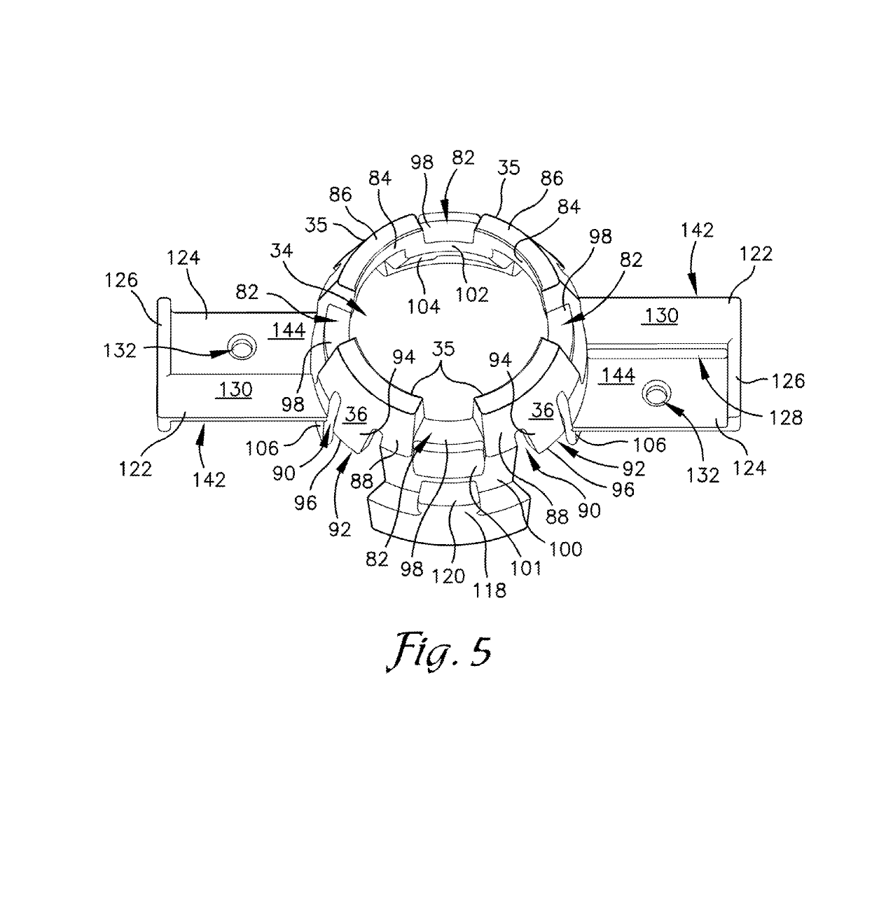

FIG. 6 is an elevational section view of the tube support assembly of FIG. 1, taken along a central longitudinal plane of the tube support assembly and viewed from the right;

FIG. 7 is a perspective view of a plurality of the tube support assemblies of FIG. 1 secured to a pair of brackets extending between building members, viewed from above and to the right;

FIG. 8 is a fractional perspective view of the assembly of FIG. 1 secured to a pair of brackets, viewed from above and to the right and depicted with building members and tubing removed for clarity;

FIG. 9 is a fractional perspective view of the assembly of FIG. 1 secured to a pair of brackets, viewed from below and to the left and depicted with building members and tubing removed for clarity.

### DETAILED DESCRIPTION

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. The drawings constitute a part of this specification and include exemplary embodiments of the present invention and illustrate various objects and features thereof.

Certain terminology will be used in the following description for convenience in reference only and will not be limiting. For example, the words “above,” “below,” “rightward,” and “leftward” will refer to directions in the drawings to which reference is made, and the words “inward” and “outward” will refer to directions toward and away from, respectively, the geometric center of the embodiment being described and designated parts thereof. The words “forward” and “rearward” will refer to directions toward the front and back, respectively, of the embodiment being described and designated parts thereof. The words “mounted,” “connected,” “attached,” and “secured” will refer to parts, elements, or components that are both formed separately or joined together, as by welding or through a mechanical coupling, or parts, elements, or components that are integrally formed together. The words “about” or “approximately” as used herein denote deviations from the exact value by +/- 10%, preferably by +/- 5%, and/or deviations in the form of changes that are insignificant to described function. Said terminology will include the words specifically mentioned, derivatives thereof, and words of a similar import.

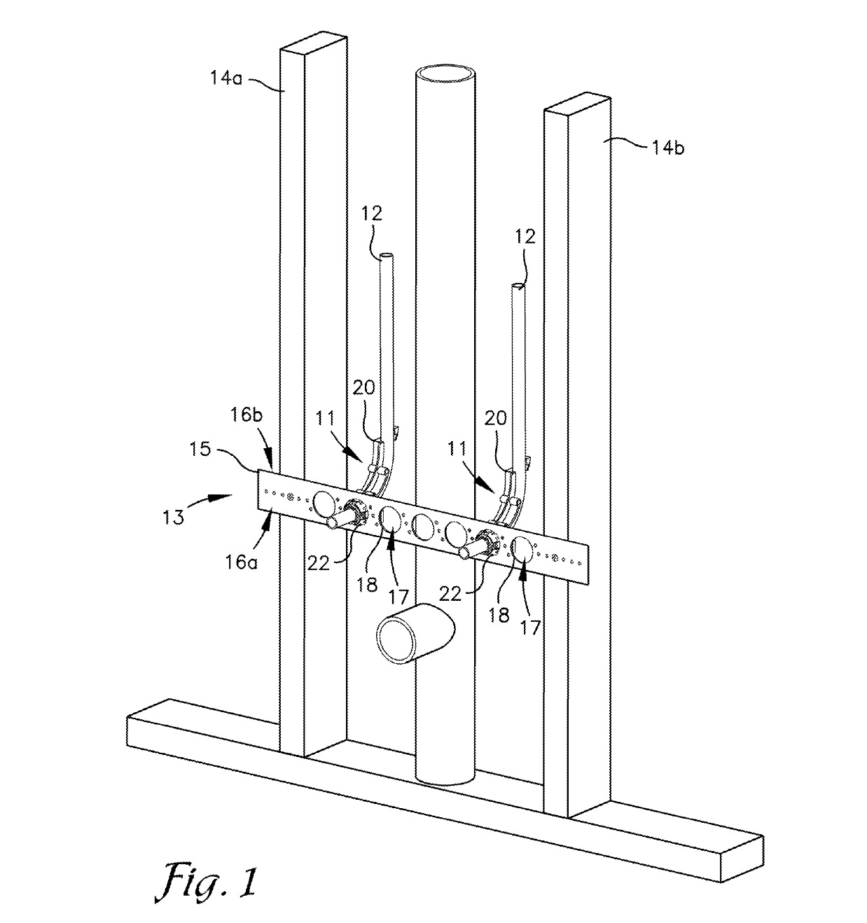

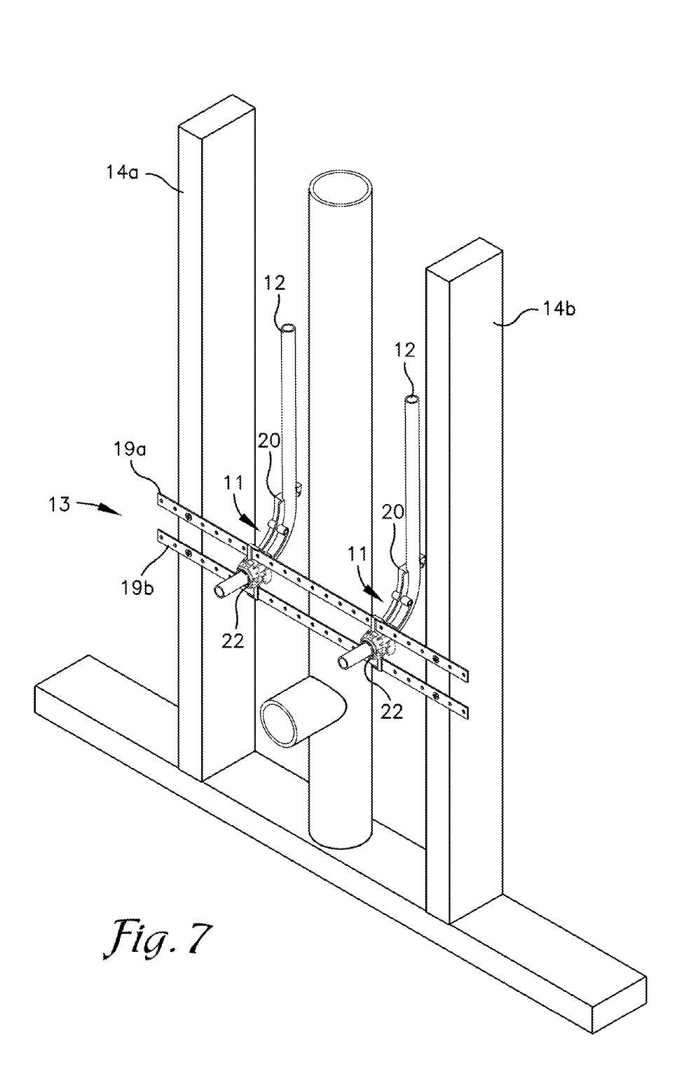

With reference to the drawings in more detail, and in particular to FIG. 1, the reference number 11 generally designates a tube hanging assembly or tube support apparatus 11 according to the present invention. The tube support apparatus 11 is generally for use in supporting a piece of flexible tubing 12 such as PEX (cross-linked polyethylene) tubing. It is foreseen, however, that the tube support apparatus 11 may be used with other types of tubing or conduit, such as electrical or communications cables, fiber optic bundles, wire bundles, or virtually any other elongate structure or member to be routed through a building structure or structural member. The tube support apparatus 11 is typically used in combination with a pipe hanger system 13 adapted to be mounted between adjacent building members such as wall studs 14a and 14b. The pipe hanger system 13 is generally shown and described herein as a type including a plumbing support strap or elongate stub out bracket 15 (see FIG. 1) with a pair of opposingly oriented first and second faces 16a and 16b which may be referred to herein as front and rear faces 16a and 16b. The support strap 15 is formed of a rigid yet bendable material such as heavy-gauge, galvanized steel and includes a plurality of access openings 17 sized to receive grommets (as described below) or other metal or plastic insulators. The access openings 17 are in axial alignment with each other and extend transversely through the front and rear faces 16a and 16b of the support strap 15, with inner circumferential edges 18 of the support strap 15 surrounding each access opening 17. It is foreseen that the tube assembly 11 may be used with a pipe hanger system 13 including a pair of spaced apart brackets 19a and 19b (see FIG. 7) which may be flat steel straps of the type referred to in the industry as “Hyco straps” or “Hyco bars.”

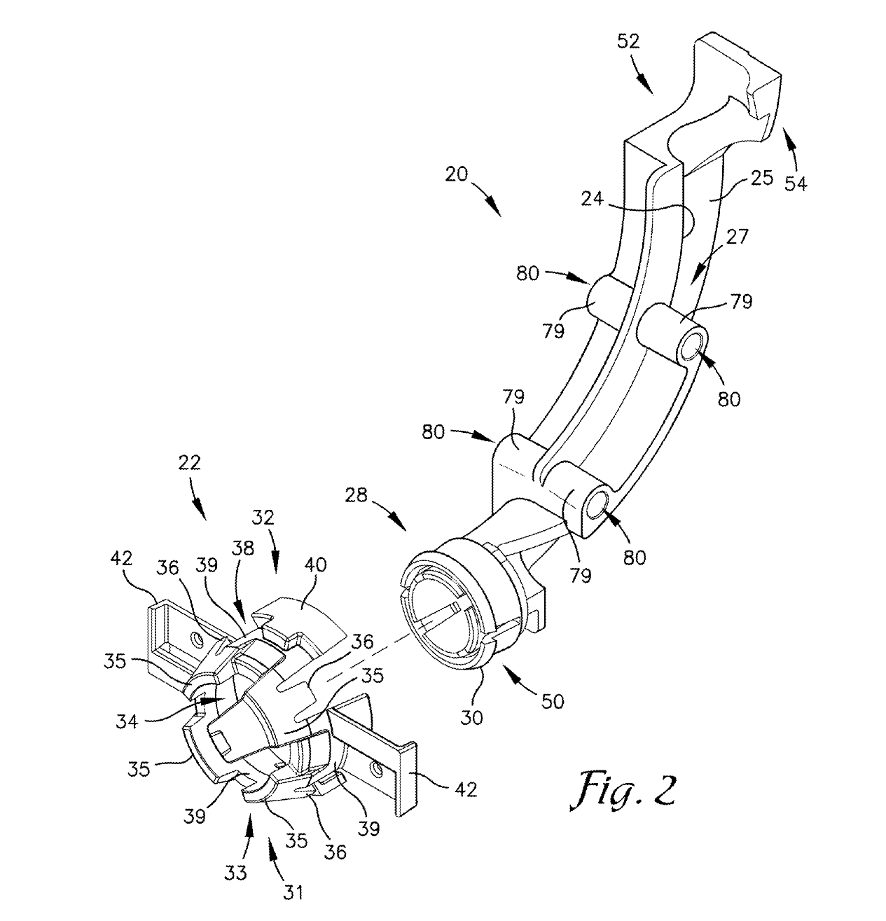

The tube support apparatus 11 is securable to the support strap 15 and comprises a guide member 20 which receives and supports the tubing 12 and a grommet or annular mount 22 which receives the guide member 20 and is securable to the support strap 15. The guide member 20 is shown and described herein as being a bend support member or bend support 20 which guides the tubing 12 through a ninety-degree bend and, as best seen in FIGS. 2, 3, and 6, includes a curved inner wall 24 and a laterally or tangentially extending side wall 25 that cooperate to partially define a channel or passageway 27 that extends through and is encircled by a head 28 on which one or more outwardly projecting barbs 30 are formed. It should be understood, however, that embodiments of the tube support assembly 11 are not limited to those incorporating bend supports; for example, it is foreseen that the head 28 and barbs 30 projecting outward therefrom may be formed on or connected to a guide member 20 configured to guide the tubing 12 along approximately straight runs or through bends of more or less than ninety degrees.

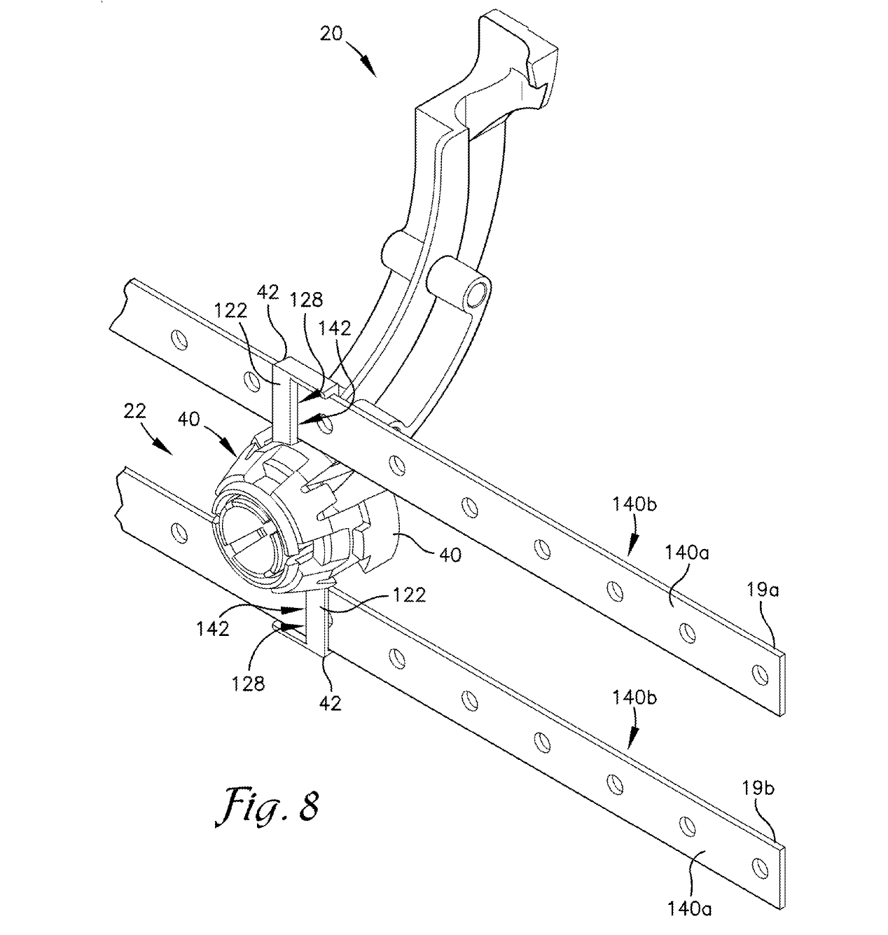

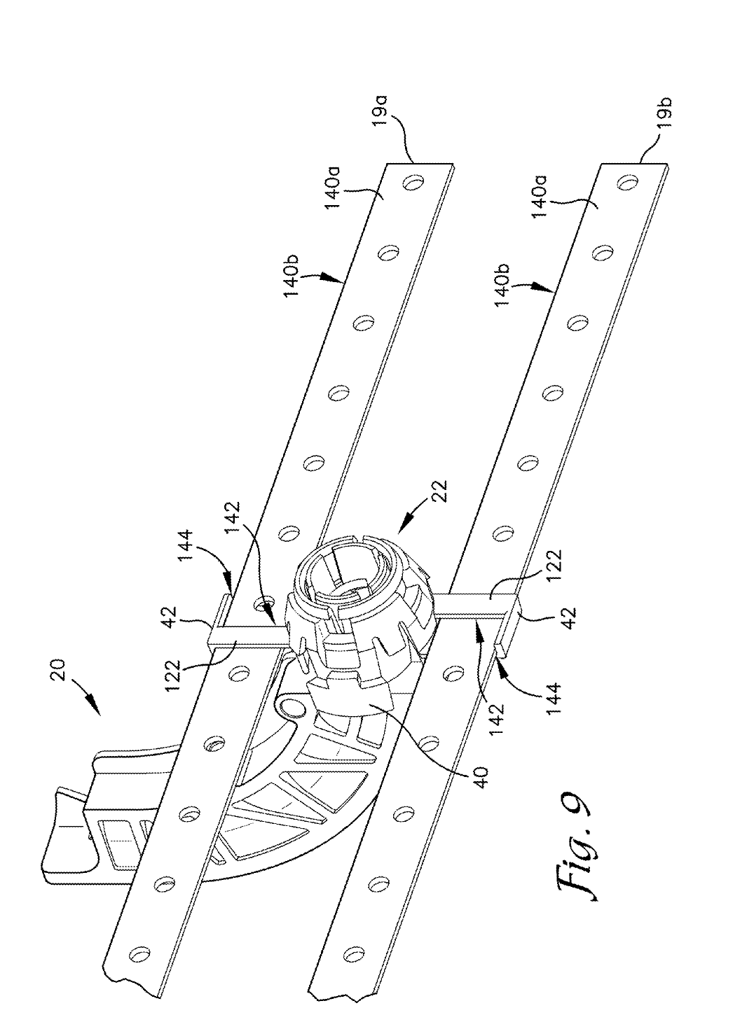

The grommet 22 is sized to receive the head 28 of the bend support 20 and includes a first or leading end 31 and a second or trailing end 32. The leading end 31 includes a radially expandable nose 33 which extends circumferentially around a guide receiving opening 34 and includes a plurality of spaced apart nose sections 35. The nose sections 35 are urged to expand outward over the barbs 30 as the head 28 of the bend support member 20 is advanced through the guide receiving opening 34, with each barb 30 contracting to catch onto one or more nose sections 35 after passing thereby such that when the grommet 22 receives the head 28, the leading end of each nose section 35 abuts against one or more of the barbs 30. A plurality of flexible fingers 36 project rearward and outward from at least one, and preferably at least two, of the nose sections 35, with each flexible finger 36 compressing radially inward as the leading end 31 of the grommet 22 is advanced selectively through one of the access openings 17 formed in the support strap 15. A neck 38, which includes a plurality of neck sections 39, extends circumferentially around the guide receiving opening 34 and rearward from the leading end 31 to the trailing end 32. The trailing end 32 includes arcuate flanges 40 which extend radially outward and rearward from at least some of the neck sections 39, with the arcuate flanges 40 situated rearward of and in spaced apart relation from the fingers 36 such that the fingers 36 and arcuate flanges 40 abut the front and rear faces 16a and 16b of the support strap 15, respectively, when the grommet 22 is secured thereto. Slotted tabs 42 extend laterally outward from at least some of the neck sections 39 proximate the trailing end 32, with the slotted tabs 42 abutting the rear face 16b of the support strap 15 when the grommet 22 is secured thereto. It is foreseen that the slotted tabs 42 may enable use of the tube support assembly 11 with a pipe hanger system 13, as shown in FIGS. 7-9, including brackets 19a and 19b, or use of the tube support assembly 11 without the pipe hanger system 13.

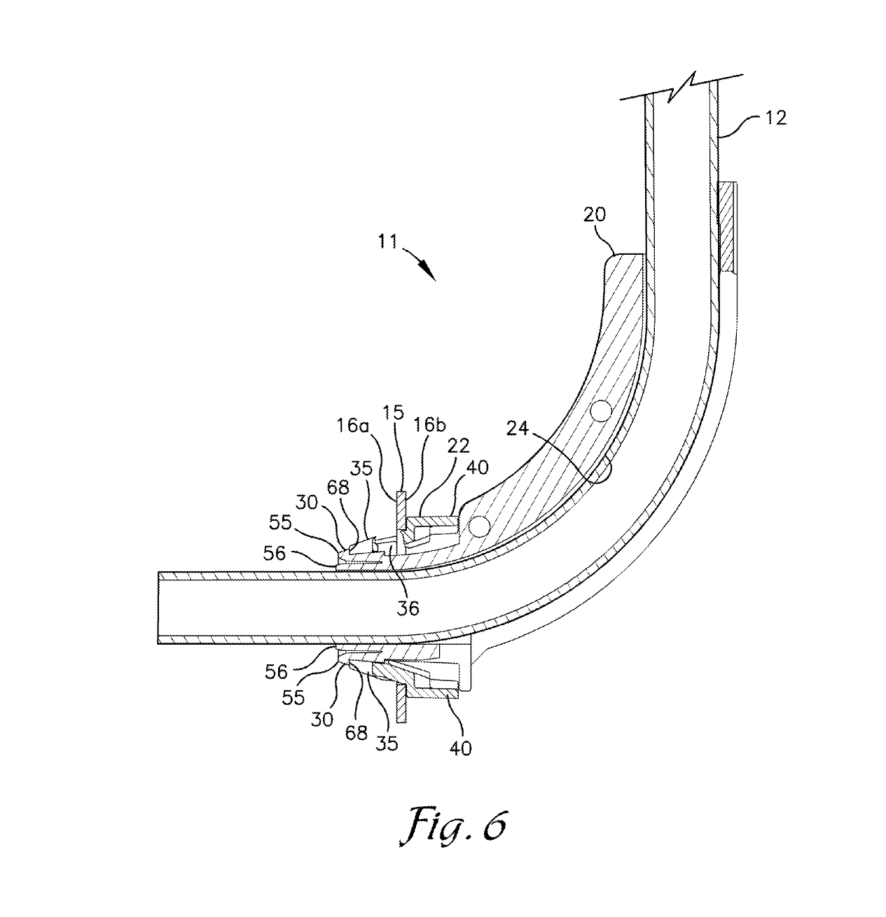

Referring now to FIGS. 2, 3, and 6, the bend support 20 extends from a first or forward end 50 to a second or rearward end 52, with the head 28 formed proximate the first end 50 and a tail 54 extending outward from the second end 52. The head 28 of the embodiment shown is generally annular and includes an outer wall 55 and an inner wall 56 which are divided or separated by an annular groove 58 that extends into the head 28 from the first end 50. The groove 58 has a V-shaped entrance opening such that the outer wall 55 has a tapered inner edge and the inner wall 56 has a tapered outer edge. The inner wall 56 is slightly longer than the outer wall 55 and thus extends slightly beyond the outer wall 55 (see FIG. 6).

The outer wall 55 of the head 28 has a slightly tapered outer surface 60, sloping outward and rearward from the forward end thereof. The outer wall includes two or more splits 62 which divide the outer wall 55 into two or more arcuate, flexible wall portions 64. One or more barbs 30 are formed on the distal end or tip 65 of each flexible wall portion 64. Each barb 30 includes an outer surface 66 which tapers outward and rearward from the respective tip 65 to a shoulder or rear surface 68 (see FIG. 6). The inner wall 56 of the head 28 forms a collet 70 which is positioned radially inward of the outer wall 55 and is separated therefrom by the annular groove 58. The collet 70 comprises a plurality of arcuate segments or fins 72 which are separated from each other by gaps or grooves 74. The tail 54 includes a generally straight outer wall section 76 which extends outward in spaced apart relation from a corresponding rearward portion of the inner wall 24 and a prong or tine 78 which extends inward from the outer wall section 76. The inner wall 24, side wall 25, head 28, and prong 78 cooperate to frictionally retain the tubing 12 in the passageway 27.

It should be noted that the bend support 20 can be used separately, without the grommet 22 of the support strap 15, to fasten a piece of tubing 12 to a building member such as a wall stud 14a or 14b and support the tubing 12 through a ninety-degree bend. To this end, the bend support 20 includes a pair of mounting bosses 79 formed on the inner wall 24 thereof and located outside of the passageway 27. Each mounting boss 79 includes a respective fastener receiving aperture 80 adapted to receive a fastener (not shown), such as a nail or screw, which can be used to fasten the bend support 20 directly to a building member. The bosses 79 are of a length selected to extend substantially across the thickness of the bend support 20. It is foreseen that the bend support 20 may comprise an arcuate body with first and second ends and a passageway formed along the body between the first and second ends wherein a head including a collet is formed proximate the first end and the passageway and the collet are sized to receive a piece of tubing as disclosed in U.S. Patent No. 8,141,831 (the “’831 Patent”) assigned to Sioux Chief Mfg. Co., Inc. of Kansas City, MO. The disclosure provided by the ‘831 Patent with respect to such arcuate bodies is incorporated herein by reference.

The grommet 22 is preferably molded of a durable plastic such as ABS (acrylonitrile butadiene styrene) or PVC. The nose sections 35, fingers 36, neck sections 39, and arcuate flanges 40 of the grommet 22 surround and define the guide receiving opening 34.

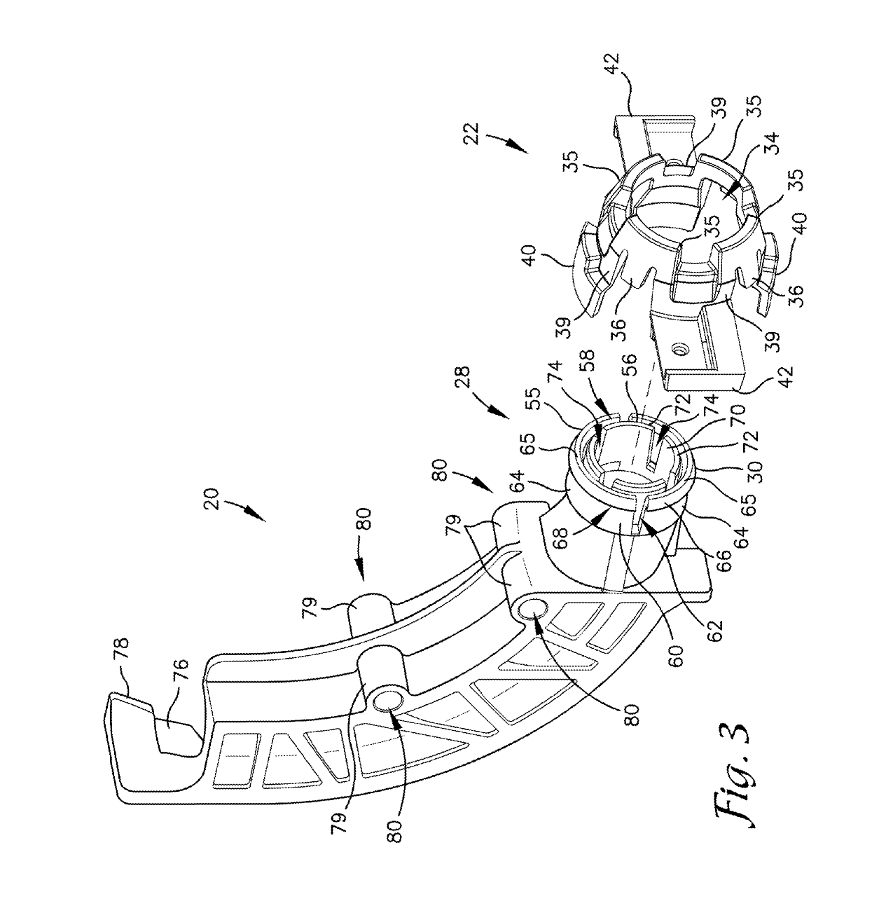

The nose sections 35 are spaced apart from one another around the circumference of the leading end of the guide receiving opening 34 and the inner, circumferential end of each nose section 35 is connected to or integrally formed with the outer, circumferential ends of the adjacent neck sections 39. Grooves 82 that may be referred to as nose grooves 82 extend radially through the nose 33 to divide the nose sections 35 from each other with each nose groove 82 oriented forward of a neck section 39 such that the nose sections 35 extend further forward than the neck sections 39 as shown in FIGS. 2 and 3. Each nose section 35 is generally arcuate and includes an inner surface 84 which is curved or contoured to receive the slightly tapered outer surface 60 of the head 28 and an end wall 86 which abuts against a rear surface 68 of a barb 30 on the outer wall 55 of the bend support head 28. The nose sections 35 further include outward-facing slanting surfaces 88 which extend radially outward and rearward in a substantially frustoconical plane. The nose 33 shown and described herein comprises four nose sections 35 and four nose grooves 82 which are situated in equidistant intervals around the circumference of the leading end of the guide receiving opening 34. It is understood that the nose 33 may include more or fewer than four nose sections 35 and four nose grooves 82 without departing from the scope of embodiments of the invention described herein.

A flexible finger 36 is integrally formed with or connected to a central portion of each nose section 35, with generally V-shaped grooves 90, which may be referred to as finger grooves 90, separating each finger 36 from the circumferential ends of the nose section 35 from which the finger 36 projects and the circumferential ends of the neck sections 39 adjacent thereto. It is foreseen that each nose section 35 may have a plurality of fingers 36 projecting outward and rearward therefrom, and it is further foreseen that fingers 36 may be formed on at least one, and preferably at least two, but not all of the nose sections 35.

The fingers 36 are generally thinner than the nose sections 35 and project rearward and outward therefrom, such that a circle circumscribing the distal ends of the fingers 36 is greater in diameter than the respective diameters of the access openings 17 through which the grommet 22 is configured to advance. Each finger 36 includes an inner surface 92, an outward-facing compression surface 94, and a rearward-facing contact surface 96. The inner surface 92 of each finger 36 is offset outward from the inner surface 84 of the nose section 35 from which the finger 36 projects, and the compression surface 94 extends in the same substantially frustoconical plane as the slanting surface 88 of the nose section 35 from which the finger 36 projects. The contact surfaces 96 of the fingers 36 are generally flat and extend in a common plane for engaging the front face 16a of the support strap 15, such that as the leading end 31 of the grommet 22 is selectively advanced through one of the access openings 17 formed in the support strap 15, the compression surfaces 94 gradually engage and slide along portions of the edge 18 and the support strap 15 forces the fingers 36 to compress or flex radially inward until the contact surfaces 96 pass through the access opening 17 and the fingers 36 abruptly flex or spring radially outward to normal or decompressed positions wherein the contact surfaces 96 extending in overlapping relationship with the front face 16a of the support strap 15 and abut portions thereof proximate to the edge 18 of the access opening 17.

The neck sections 39 are spaced apart from one another around the guide receiving opening 34 and the circumferential ends of each neck section 39 are connected to or integrally formed with circumferential ends of the adjacent nose sections 35. The fingers 36 and finger grooves 90 divide the neck sections 39 from each other and each neck section 39 extends further rearward than the contact surfaces 96 of the fingers 36 (see FIGS. 2 and 3). Each neck section 39 is generally arcuate and includes a forward-facing surface 98 that extends between the adjacent nose sections 35 and an outward-facing or outer surface 100 which is curved or contoured to fit snugly against an edge 18 when the leading end 31 of the grommet 22 is advanced through an access opening 17. Offset surfaces 101 (which may be slanted or flat or partially slanted and partially flat) extend rearward from the upper edge of the forward-facing surfaces 98 into the outer surfaces 100. Each neck section 39 further includes a first inner surface 102 which is curved or contoured to receive the slightly tapered outer surface 60 of the head 28 and a second inner surface 104 which is tapered and extends radially outward and rearward from the first inner surface 102 in a substantially frustoconical plane. Each neck section 39 supports an arcuate flange 40 or a tab 42, with indentations or notches (not shown) formed in rear portions of the neck sections 39 that support arcuate flanges 40 and generally arcuate support walls 106 extending rearward from the neck sections 39 that support tabs 42.

Each arcuate flange 40 extends radially outward from a rear portion of a neck section 39. The grommet 22 may comprise a pair of diametrically opposed arcuate flanges 40 which generally lie in the same plane and are in axial alignment with each other when the grommet 22 is secured to the support strap 15, and it is foreseen that the grommet 22 may include more or fewer than two arcuate flanges 40. The arcuate flanges 40 are generally arcuate and extend rearward to form rear surfaces which extend in closely spaced relation with a mounting boss 79 and/or an outwardly extending stop 115 formed proximate the first end 50 of the bend support 20 when the grommet 22 is secured to the support strap 15 and receives the head 28 of the bend support 20. Protruding shoulders 118 extend forward from central portions of each arcuate flange 40 to form forward-facing contact surfaces 120 that are generally flat and extend in a common plane for engaging the rear face 16b of the support strap 15. The contact surfaces 120 of the shoulders 118 are spaced apart from the contact surfaces 96 of the fingers 36 a distance corresponding to the thickness of the support strap 15, such that when the leading end 31 of the grommet 22 is selectively advanced through one of the access openings 17 formed in the support strap 15 and the contact surfaces 96 abut the front face 16a of the support strap 15 as described previously, the contact surfaces 120 simultaneously abut portions of the rear face 16b of the support strap 15 proximate to the edge 18 of the access opening 17 and the arcuate flanges 40 and fingers 36 cooperate to secure the grommet 22 to the support strap 15.

Each tab 42 extends laterally outward from a rear portion of a neck section 39. The grommet 22 may comprise a pair of diametrically opposed tabs 42 which are in axial alignment with each other when the grommet 22 is secured to the support strap 15, and it is foreseen that the grommet 22 may include more or fewer than two tabs 42. Each tab 42 includes a first or forward slat 122 and a second or rearward slat 124 which extend outward to a common end member 126 and are offset or divided from each other by a slot 128, with the forward slats 122 connected to rear portions of neck sections 39 and the rearward slats 124 connected to forward portions of support walls 106. The axially aligned tabs 42 are substantially identical in structure except for their mirrored configuration such that the forward slat 122 of the tab 42 which extends rightward from the grommet 22 is oriented above the rearward slat 124 thereof and the forward slat 122 of the tab 42 which extends leftward from the grommet 22 is oriented below the rearward slat 124.

The forward slats 122 include forward-facing contact surfaces 130 that are generally flat and extend in a common plane for engaging the rear face 16b of the support strap 15. The contact surfaces 130 of the forward slats 122 are spaced apart from the contact surfaces 96 of the fingers and extend in substantially the same plane as the contact surfaces 120 of the shoulders 118, such that when the leading end 31 of the grommet 22 is selectively advanced through an access opening 17 with the contact surfaces 120 abutting portions of the rear face 16b of the support strap 15 proximate to the edge of the access opening 17 as described previously, the contact surfaces 130 of the forward slats simultaneously abut portions of the rear face 16b of the support strap 15 situated between the access opening 17 through which the leading end 31 extends and its neighboring access openings 17. The tabs 42 thus cooperate with the arcuate flanges 40 and the fingers 36 to secure the grommet 22 to the support strap 15.

Each rearward slat 124 includes a respective fastener receiving aperture 132 adapted to receive a fastener (not shown), such as a nail or screw, which can be used to securably fasten the grommet 22 directly to a building member such as a wall stud 14a or 14b or directly to a subfloor or floorboards (not shown) such that the grommet can receive the head 28 of a bend support member 20. The tabs 42 thus facilitate use of the tube support assembly 11 separate from a pipe hanger system 13 including a support strap 15 or a pair of brackets 19a, 19b.

Referring now to FIGS. 7-9, when the tube support assembly 11 is used with a pipe hanger system 13 including a pair of spaced apart brackets 19a and 19b the grommet 22 is oriented such that the arcuate flanges 40 are in axial alignment with each other and the tabs 42 are in axial alignment with each other. The brackets 19a and 19b, which lie generally in the same plane and may be referred to herein as upper and lower brackets 19a and 19b, each include a generally flat first or front face 140a and a generally flat second or rear face 140b and extend through the slots 128 formed in the tabs 42 with the front faces 140a extending against rearward-facing sliding surfaces 142 formed on the first slats 122 and the rear faces 140b extending against forward-facing sliding surfaces 144 formed on the second slats 124. The fit between the first faces 140a and the sliding surfaces 142 and the fit between the second faces 140b and the sliding surfaces 144 cooperate to frictionally secure the grommet 22 to the brackets 19a and 19b, enabling the grommet 22 to be somewhat fixedly positioned while still allowing the grommet 22 to be selectively slid along the brackets 19a and 19b. It should be understood that when the tube support assembly 11 is used with brackets 19a and 19b, the tabs 42 typically secure the grommet 22 to the brackets 19a and 19b without cooperation from the fingers 36 and/or arcuate flanges 40.

Operation of the tube support apparatus 11 is now described in accordance with an embodiment of the invention. A support strap 15 is mounted to extend between wall studs 14a and 14b and the tube support apparatus 11 is presented with the bend support 20 and the grommet 22 spatially separated as shown in FIGS. 2 and 3. The grommet 22 is advanced to a position where the guide receiving opening 34 is coaxially aligned with a selected access opening 17, the leading end 31 is slightly rearward of the rear face 16b, and the grommet 22 is oriented such that the arcuate flanges 40 are axially aligned with each other, and the tabs 42 are axially aligned with each other. The grommet 22 is moved forward with its leading end 31 advancing through the access opening 17 and its fingers 36 compressing radially inward as the compression surfaces 94 thereof gradually engage with and slide along the edge 18 surrounding the access opening 17. As the leading end 31 is further advanced through the hole 17, the contact surfaces 96 of the fingers 36 pass through the access opening 17 and abruptly decompress and expand outward such that the contact surfaces 96 abut portions of the front face 16a of the support strap 15 proximate to the edge 18. Concomitantly with the outward expansion of the fingers 36, the contact surfaces 120 of the arcuate flanges 40 abut portions of the rear face 16b of the support strap 15 proximate to the edge 18 of the access opening 17 and the contact surfaces 130 abut portions of the rear face 16b of the support strap 15 situated between the selected access opening 17 and its neighboring access openings 17. The grommet 22 is thereby secured to the support strap 15 and is positioned as shown in FIG. 1.

In foreseen uses where when the tube support assembly 11 is used with a pipe hanger system 13 including a pair of brackets 19a and 19b, the grommet 22 is oriented with the tabs 42 axially aligned with each other and the arcuate flanges 40 in axial alignment with each other, and the brackets 19a and 19b are spaced apart from each other sufficiently for the nose 33 of the grommet 22 to extend therebetween. The grommet 22 is slid onto ends of the brackets 19a and 19b with the first and second faces 140a and 140b of the bracket 19a fitting against the sliding surfaces 142 and 144, respectively, of one tab 42 and the first and second faces 140a and 140b of the bracket 19b fitting against the sliding surfaces 142 and 144, respectively, of the other tab 42. With the grommet 22 so positioned, the brackets 19a and 19b are mounted to extend between wall studs 14a and 14b and the grommet 22 is selectively slid along the brackets 19a and 19b to a desirable position between the wall studs 14a and 14b, at which point friction is generated by the fit between the sliding surfaces 142 and the first faces 140a and the fit between the sliding surfaces 144 and the second faces 140b, thereby securing the grommet 22 to the brackets 19a and 19b. It is understood that the process described above may be repeated such that a plurality of grommets 22 are secured the brackets 19a and 19b as shown in FIG. 7.

In foreseen uses where the tube support assembly 11 is used separate from a pipe hanger system 13 and is mounted directly to a building member such as a wall stud 14a or 14b or directly to subfloor or floorboards, the grommet 22 is advanced to a position where the guide receiving opening 34 is coaxially aligned with a bore (not shown) formed in the building member or subfloor and the nose 33 of the leading end 31 of the grommet 22 extends into the bore until the contact surfaces 130 of the tabs 42 abut the building member or the subfloor. With the grommet 22 so oriented, a fastener is extended through the fastener receiving aperture 132 of each tab 42 to secure the grommet 22 to the building member or the subfloor.

With the grommet 22 secured to the support strap 15 (or alternatively secured to the brackets 19a and 19b or to the building member or the subfloor), the bend support 20 is advanced to a position where the head 28 of the bend support 20 is coaxially aligned with the guide receiving opening 34 of the grommet 22 and the head 28 is slightly rearward of the trailing end of the guide receiving opening 34. As the bend support 20 is advanced further forward and the head 28 extends into the guide receiving opening 34 of the grommet 22, the outer surfaces 66 of the barbs 30 engage the tapered inner surfaces 104 of the neck sections 39 and the taper acts to compress the flexible wall portions 64 of the head 28 inward. Continued application of force to the bend support 20 urges the flexible wall portions 64 first against the inner surfaces 102 of the neck sections 39 and then against the inner surfaces 84 of the nose sections 35, further compressing the flexible wall portions 64. As the barbs 30 bear against the nose sections 35, the nose sections 35 may flex outward somewhat. Once the barbs 30 pass the end walls 86 of the nose sections 35, the flexible wall portions 64 spring outward such that the rear surfaces 68 of the barbs 30 will extend outward and in overlapping and abutting relationship with the end walls 86 to prevent the head 28 from being withdrawn from the guide receiving opening 81. The outwardly extending stop 115 of the bend support 20 may engage the rear surface of an arcuate flange 40 to prevent the head 28 from being pushed completely through the guide receiving opening 34. The bend support 20 is thus received by and rotatable relative to the grommet 22.

To install the tubing 12 into the tube support assembly 11, the tubing 12 is generally slid directly into the head 28 of the bend support 20 from the rear side thereof and bent along the walls 24 and 25 of the bend support 20. The tubing 12 is then hooked by the prong 78 formed on the tail 54, such that the tubing 12 is applied to the bend support 20 and extends through the passageway 27 without having to thread the entire length of the tubing 12 through the bend support 20. When the tubing 12 is applied to the bend support 20 and the bend support 20 is received by the grommet 22, the tubing extends through the guide receiving opening 34 of the grommet 22. It is understood that the tubing may be applied to the bend support 20 either before or after the bend support 20 is received by the grommet 22.

Many different arrangements of the various components depicted, as well as components not shown, are possible without departing from the scope of the claims below. Embodiments of the technology have been described with the intent to be illustrative rather than restrictive. Alternative embodiments will become apparent to readers of this disclosure after and because of reading it. Alternative means of implementing the aforementioned can be completed without departing from the scope of the claims below. Identification of structures as being configured to perform a particular function in this disclosure is intended to demarcate those structures as including a plurality of possible arrangements or designs within the scope of the disclosure and readily identifiable by one of skill in the art to perform the particular function in a similar way without specifically listing all such arrangements or designs. Certain features and sub-combinations are of utility and may be employed without reference to other features and sub-combinations and are contemplated within the scope of the claims.

As used in the claims, identification of an element with an indefinite article “a” or “an” or the phrase “at least one” is intended to cover any device or assembly including one or more of the elements at issue. Similarly, references to first and second elements, or to a pair of elements, is not intended to limit the claims to such assemblies including only two of the elements, but rather is intended to cover two or more of the elements at issue. Only where limiting language such as “a single” or “only one” with reference to an element, is the language intended to be limited to one of the elements specified, or any other similar limited number of elements.

What is claimed is:

1. A tube support apparatus for supporting a piece of flexible tubing through a run, the tube support apparatus comprising:
a guide member including a head having a barb formed thereon, the barb projecting radially outward from the head; and
a grommet securable to a support strap, the grommet including a nose comprising a plurality of outwardly expandable nose segments extending around a grommet opening, the nose including a plurality of fingers, each of the plurality of fingers projecting rearward and outward from the nose and being compressible inward relative to the grommet opening;
wherein:
the head is advanceable through the grommet opening such that the barb urges the plurality of outwardly expandable nose segments outward until the barb passes past a leading end of the nose, whereupon the plurality of outwardly expandable nose segments contract around the head rearward of the barb; and
the nose is advanceable through an access opening formed in the support strap such that the plurality of fingers are compressed inward until distal ends of the plurality of fingers pass a front face of the support strap, whereupon the distal ends of the plurality of fingers expand outward in overlapping relationship with the front face of the support strap.

2. The tube support apparatus as in claim 1, further comprising one or more flanges formed rearward of the distal ends of the plurality of fingers a distance corresponding to a thickness of the support strap.

3. The tube support apparatus as in claim 2, wherein upon advancement of the nose through the access opening, the one or more flanges abut against a rear face of the support strap.

4. The tube support apparatus as in claim 1, wherein the nose extends circumferentially around the grommet opening such that the plurality of fingers project radially outward from the nose.

5. The tube support apparatus as in claim 4, wherein a diameter of a circle circumscribing the distal ends of the plurality of fingers is greater than the diameter of the access opening.

6. The tube support apparatus as in claim 1, wherein each of the plurality of fingers includes a respective compression surface, the compression surfaces engaging an edge of the access opening upon advancement of the nose therethrough.

7. The tube support apparatus as in claim 1, wherein the plurality of outwardly expandable nose segments are separated from each other by a plurality of nose grooves.

8. The tube support apparatus as in claim 1, further comprising one or more tabs extending outward from the grommet, each of the one or more tabs having a respective slot formed therein.

9. The tube support apparatus as in claim 8, wherein each of the one or more tabs includes a forward slat and a rearward slat spaced apart from each other by the respective slot.

10. The tube support apparatus as in claim 8, wherein the one or more tabs is a pair of tabs, the pair of tabs extends outward from the grommet in laterally opposite directions.

11. A support assembly for supporting an elongate member routed through a building structure, the support assembly comprising:
a grommet extending from a leading end to a trailing end;
the leading end having a nose extending around a guide receiving opening formed in the grommet, a plurality of flexible fingers projecting rearward and outward from the nose;
the trailing end having a flange, the flange situated rearward of and in spaced apart relation from the plurality of flexible fingers such that when the grommet is secured to a support strap, the plurality of flexible fingers abut against a front face of the support strap and the flange abuts against a rear face of the support strap; and
a bend support extending from a first end to a second end and defining a passageway extending therethrough, the bend support having a head formed proximate the first end, the head including a barb projecting outward, the head advanceable through the guide receiving opening to secure the bend support to the grommet;
wherein the plurality of flexible fingers are compressible radially inward and expandable radially outward, and the barb is compressible radially inward and expandable radially outward.

12. The support assembly as in claim 11, wherein advancement of the leading end of the grommet through an access opening formed in the support strap engages the plurality of flexible fingers with an edge of the support strap such that the plurality of flexible fingers compress radially inward.

13. The support assembly as in claim 12, wherein when the leading end of the grommet is advanced such that distal ends of the plurality of flexible fingers pass through the access opening, the plurality of flexible fingers expand radially outward.

14. The support assembly as in claim 11, wherein advancement of the head through the guide receiving opening engages the barb with the nose such that the barb compresses radially inward and the nose expands radially outward.

15. The support assembly as in claim 14, wherein when the head is advanced such that the barb passes the nose, the barb expands radially outward.

16. The support assembly as in claim 11, further comprising one or more tabs extending laterally outward from the trailing end of the grommet, each of the one or more tabs having a slot formed therein.

17. The support assembly as in claim 16, wherein each of the one or more tabs includes a forward slat and a rearward slat spaced apart from each other by the respective slot, the forward slat positioned to engage a rear face of the support strap when the grommet is secured thereto.

18. The support assembly as in claim 17, wherein an aperture is formed in the rearward slat, the aperture configured to receive a fastener for securing the grommet to a building member.

19. The support assembly as in claim 16, wherein the slot of each of the one or more tabs is configured to receive a bracket such that opposing faces of the bracket engage corresponding contact surfaces of the tab to enable selective sliding of the grommet along the bracket.

20. A method of supporting a piece of flexible tubing relative to a support structure, the method comprising:
advancing a leading end of a grommet through an access opening formed in the support structure, the grommet defining a guide receiving opening and including a plurality of fingers projecting rearward and radially outward from the leading end;
compressing the plurality of fingers radially inward as the leading end advances through the access opening;
allowing the plurality of fingers to expand radially outward after distal ends of the plurality of fingers pass through the access opening such that the distal ends of the plurality of fingers abut against a front face of the support structure;
advancing a head of a guide member through the guide receiving opening of the grommet, the head including a barb projecting radially outward therefrom;
urging a plurality of nose segments of the grommet to expand radially outward as the barb advances through the guide receiving opening; and
allowing the plurality of nose segments to contract around the head rearward of the barb when the barb passes the plurality of nose segments.
